(19) United States
(12) Patent Application Publication
(10) Pub. No.: US 2023/0401508 A1
(43) Pub. Date: Dec. 14, 2023

(54) SYSTEMS AND METHODS FOR JOBSITE ENVIRONMENTAL, SOCIAL, AND GOVERNANCE MANAGEMENT

(71) Applicant: ESG OnSite Inc., Houston, TX (US)

(72) Inventors: Joshua LANCASTER, Houston, TX (US); Lance RICHARDSON, Houston, TX (US)

(21) Appl. No.: 18/208,471

(22) Filed: Jun. 12, 2023

Related U.S. Application Data
(60) Provisional application No. 63/366,295, filed on Jun. 13, 2022.

(51) Int. Cl. G06Q 10/0635; G08B 25/01; G06Q 10/0631

(52) U.S. Cl. CPC G06Q 10/0635; G06Q 10/06311; G08B 25/016

(57) ABSTRACT

A method for controlling a job site includes generating a team profile by associating a plurality of team member attributes with a job site that corresponds to a first physical location within a job field. The method further includes generating a work profile by associating a plurality of job safety attributes from a job safety database with the job site or a plurality of job step attributes from a job step database with the job site. The method further includes generating a dynamic compliance profile by receiving a plurality of job site inputs at the job site and comparing the plurality of job site inputs against both the team profile and the work profile. The method further includes alerting a user when a compliance metric of the dynamic compliance profile is out of compliance.

### CROSS-REFERENCE TO RELATED APPLICATIONS

This application claims the benefit of U.S. Provisional Application No. 63/366,295, filed Jun. 13, 2022 and titled “Systems and Methods for Jobsite Environmental, Social, and Governance Management.”

### BACKGROUND

Jobsites, such as those in an oil and gas field, are often situated in remote locations away from a central control or management office where employees, and other non employee workers, engage in activities on behalf of the company. At the jobsite, team members, to include non employee workers, engage in any of a range of tasks that may involve certain health and safety risks. For the sake of non-limiting example, team members at an oil field jobsite engage in welding, piping fitting, lifting, and other tasks that may expose such team members to risks. The jobsite itself may be associated with certain risks, including risks associated with certain process equipment, field conditions (e.g., gasses, weather, and so on), and operational or work activities from other teams in close proximity. Additionally, some risks remain unknown or undisclosed to certain team members on the jobsite, which leads to unsafe working conditions.

Risks associated with emissions are also present such as the output of greenhouse gasses or other gasses or pollutants. For example, team members at an oil field jobsite may utilize trucks, heavy equipment, generators, compressors, and the like in order to complete certain tasks at the job site, any of which may emit emissions or other pollutants. Certain jobsites, or certain tasks on a jobsite, may emit more or less emissions based, in part, on the type of equipment and nature of the job task. These emission risks also lead to unsafe working conditions.

### SUMMARY

A method for controlling a job site includes generating a team profile by associating a plurality of team member attributes with a job site that corresponds to a first physical location within a job field. The method further includes generating a work profile by associating a plurality of job safety attributes from a job safety database with the job site or a plurality of job step attributes from a job step database with the job site. The method further includes generating a dynamic compliance profile by receiving a plurality of job site inputs at the job site and comparing the plurality of job site inputs against both the team profile and the work profile. The method further includes alerting a user when a compliance metric of the dynamic compliance profile is out of compliance.

A method for controlling a job site includes generating a team member compliance metric in response to a first input associated with a physical presence of a team member on a job site that corresponds to a first physical location within a job field. The method further includes generating a work profile compliance metric in response to a second input associated with an acknowledgment of a hazard on the job site or an acknowledgment of a safety protocol of the job site. The method further includes generating real-time feedback, based on the compliance metrics, associated with hazardous conditions at the job site. The method further includes alerting a plurality of users, at least one of the plurality of users being a remote user, at least one of the plurality of users being the team member, of the hazardous conditions.

A non-transitory computer-readable medium, when executed by a processor, causes the processor to generate a team profile by associating a plurality of team member attributes with a job site that corresponds to a first physical location within a job field. The processor is further caused to generate a work profile by associating a plurality of job safety attributes from a job safety database with the job site or plurality of job step attributes from a job step database with the job site. The processor is further caused to generate a dynamic compliance profile by receiving a plurality of job site inputs at the job site and comparing the plurality of job site inputs against both the team profile and the work profile. The processor is further caused to alert a user when a compliance metric of the dynamic compliance profile is out of compliance.

### BRIEF DESCRIPTION OF THE DRAWINGS

Accordingly, systems, methods, and non-transitory computer-readable mediums are disclosed herein. In the drawings:

FIG. 1 depicts a schematic view of an example job field;

FIG. 2 is a functional diagram of an example platform for controlling a jobsite;

FIG. 3A depicts a functional diagram of an example home dashboard;

FIG. 3B depicts a functional diagram of an example work dashboard;

FIG. 3C depicts a functional diagram of an example workflow for controlling a jobsite;

FIG. 4A depicts a schematic diagram of an example computer system implementing various operations of the examples described herein;

FIG. 4B depicts a schematic diagram of a distributed platform implementing various operations of the examples described herein;

FIGS. 5-13 depict examples of user interfaces;

FIG. 14 depicts an example flow diagram of a method for controlling a jobsite; and

FIG. 15 depicts another example flow diagram of a method for controlling a jobsite.

### NOTATION AND NOMENCLATURE

Certain terms are used throughout the following description and claims to refer to particular system components and configurations. As one of ordinary skill will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”.

### DETAILED DESCRIPTION

The description that follows includes sample systems, methods, apparatuses, and non-transitory computer-readable mediums that embody various elements of the present disclosure. However, it should be understood that the described disclosure may be practiced in a variety of forms in addition to those described herein.

The following disclosure relates generally to systems, methods, apparatuses, and non-transitory computer-readable mediums for controlling a jobsite. Without limitation, a “jobsite,” as used herein, may include substantially any location at which workers or team members complete tasks of a job. For example, a jobsite may include a physical location within a job field, such as an oilfield. At an oilfield jobsite, team members may complete a variety of tasks, often specialized to the work at hand, including welding, piping fitting, lifting, and other tasks. Other jobsites may include those located at a construction site, a retail location, a repair shop, and/or other locations where specialized work is completed. Accordingly, it will be appreciated that while the systems and methods are generally described herein with respect to a jobsite of the oilfield, this is for purposes of non-limiting illustration. The various jobsites discussed herein may be a jobsite of a different industry or location without departing from the scope of the present disclosure.

The present disclosure allows team members to control and manage certain environmental, health, and safety risks of the jobsite, including managing, and facilitating compliance with, the environmental, social, and governmental (“ESG”) metrics of a given jobsite. The disclosure defines a platform that automatically connects team members at a physical location with a job field, such as the oil field, with supervisory and other personnel not at the physical location to facilitate the management of the jobsite and collecting and analyzing information associated ESG metrics and compliance. In one example, the platform allows team members, supervisory personnel, or other users to generate a series of profiles that create a virtual record for a given jobsite. Example profiles include a team profile, a work profile, and an emissions profile among other profiles that may be warranted for managing the jobsite and collecting and analyzing information associated with ESG metrics and compliance. As described in greater detail below, the team profile may be associated with, and built out from, the team members assigned to a given jobsite. The work profile may be associated with, and built out from, the safety requirements, operational tasks, and/or other information for a given jobsite. The emissions profile may be associated with, and built out from, the emissions output of various end points (e.g., exhaust from equipment, fumes, and so on) for a given jobsite.

The platform allows users to generate a dynamic compliance profile based, in part, by receiving a plurality of jobsite inputs associated with one or more of the profiles. For example, a dynamic compliance profile may be generated by receiving a plurality of jobsite inputs at the jobsite that are associated with the team profile, the work profile, and the emissions profile. The jobsite inputs may be compared to a standard or baseline value, or other value of the respective profile, in order to determine a compliance metric. In one example, a team member compliance metric may be generated by comparing the jobsite input to an associated value of the team profile in order to track a physical presence of the team member on the job site. In another example, a work profile compliance metric may be generated by comparing the jobsite input to an associated value of the work profile in order to track and determine an acknowledgment of a hazard on the job site, an acknowledgment of safety protocol on a jobsite, and/or other messages relating to job safety or job tasks. In another example, an emission compliance profile is generated by comparing the jobsite input (including inputs derived from, or automatically processed by, various sensors) to an associated value of the emissions profile to identify and track emissions output at the jobsite. In other circumstances, other compliance metrics may be determined and tracked.

The platform described herein is broadly configured to provide updates to team members as conditions change on the jobsite. In one example, the platform is configured to provide updates to a team member of a first crew in response to a second crew entering the job site, such as the second crew entering the jobsite at a later time. For the sake of illustration, the second crew may be engaged with a type of work that potentially introduces new hazards to the jobsite, and which may require the first crew to take additional precautions or otherwise be aware of the changed safety conditions. For example, the second crew may be involved in welding work at one portion of a plant or operating facility, thus increasing risk of emissions or explosions at the jobsite, and the first crew may be involved in generally unrelated pump repair work at another portion of the plant or operating facility. In conventional systems, the first crew remains unaware the presence of the second crew, much less the hazards presented by the welding activities. According to the systems and techniques described herein, the first crew and second crew may each be registered with the platform in a manner that may allow for real-time generation of the dynamic compliance profile. When the second crew arrives on the jobsite, the team member profile can be associated with the team member attributes of the second crew, in addition to any job safety attributes and job step attributes. Accordingly, the platform may continually update the dynamic compliance profile including the attributes of the second crew. Additionally, the platform may transmit updates of the dynamic profile to the first crew in response to the second crew arriving on site, a change in a safety condition (caused by the second crew or otherwise), in addition to other dynamic updates as the first and second crew complete work on the jobsite. As such, the first crew may take action to mitigate risk to itself introduced by the second crew.

In some examples, the platform allows the dynamic compliance profile to be transmitted to a remote management site for such risk mitigation. For example, data associated with the compliance of team members to safety protocols, job steps, time on the job site, and the like can be transmitted to a control of management site. Accordingly, supervisory personnel may receive compliance related data from multiple different jobsites, multiple different crews, and multiple different equipment components across a job field. The compliance related data may be used by supervisory personnel to identify gaps in safety procedures, and as well track emissions data over time in order to satisfy ESG criteria.

Conventional job safety programs do not provide team members with jobsite specific information in real-time, nor do they provide team members with real-time updates as conditions change on the jobsite. In particular, conventional systems rely on oral communication at the beginning of job, sometimes accompanied by a written plan. The written plan may become immediately out of date, and team members lack the ability to learn of emerging health and safety updates as they perform work on the jobsite. Further, team members may have no readily available manner to check compliance against safety and operational protocols as the work is completed. Conventional systems also lack any manner of collecting emission data for individual end points at the jobsite, much less collecting and tracking such information over time in order to meet ESG criteria. Using the platform of the present disclosure, team member tracking, safety and job step compliance, and emissions monitoring is captured in real-time, and presented in an integrated approach that allows users to meet ESG goals with a single platform.

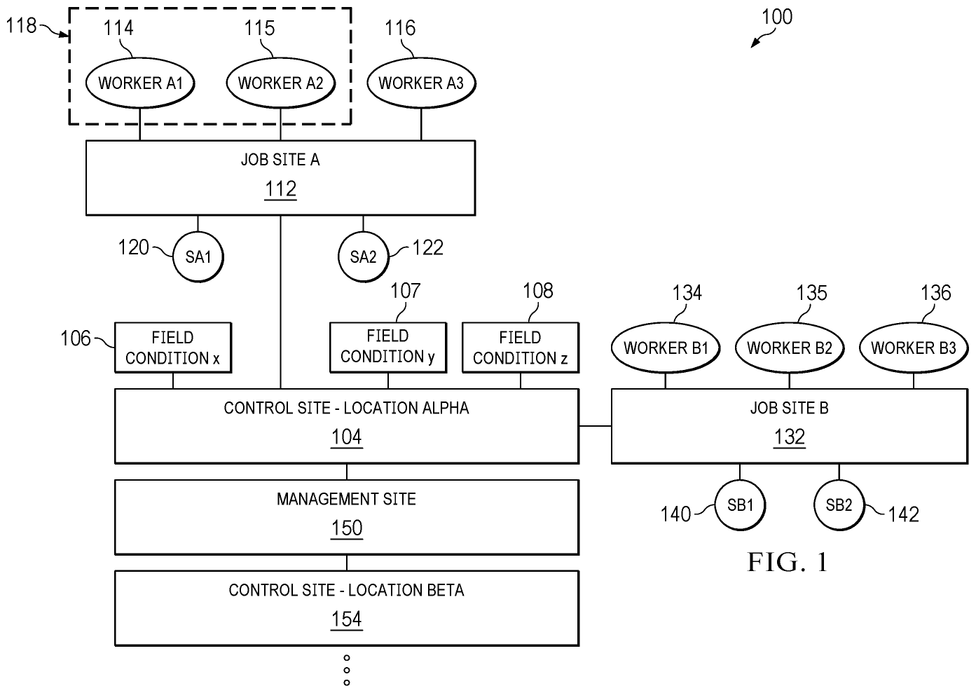

Turning to the drawings, for purposes of illustration, FIG. 1 depicts an example job field 100. The job field 100 may be an oil filed, construction site, or other field or region in which one or more worksites are located. The job field 100, for purposes of illustration, may be an oil field, such as that at which oil is produced, processed, and sold to downstream parties. For purposes of illustration, the job field may include a control site 104, a job site A 112, and a job site B 132. The control site 104 may include certain centralized systems or controls of the job field, such as those associated with oil field monitoring and control. The jobs sites 112, 132 may be physical locations within the oil field at which certain specialized tasks are completed. In the context of the oil field, this may include, without limitation, tasks related welding, piping fitting, lifting, heavy machinery operation, and others.

The jobsite A 112 may include a plurality of team members engaged in the specialized tasks, such as workers 114, 115, 116. In some cases, a subset of workers 118 may be associated with a first crew or contractors, whereas the remaining workers may be associated with another crew or contractor, despite all such workers engaged in the completion of specialized tasks in close proximity to one another on the jobsite 112. The jobsite A 112 may optionally include sensors 120, 122. The sensor 120, 122 may be configured to measure certain attributes of the jobsite 100, while the work is completed, such as measuring emissions and pollutants. The jobsite 112 may be at a first physical location in the job field 100. The jobsite B 132 may be located at a second physical location in the job field. The jobsite B 132 may be substantially analogous to the jobsite A 112 and may include workers 134, 135, 136 and sensors 140, 142. In the illustrative example of FIG. 1, all workers 134, 135, 136 may be part of the same crew.

As further shown in FIG. 1, the job field 100 may be associated field conditions, such as field condition y 107, field condition x 106, and field conditions z 108. The field conditions may correspond to any of a variety of conditions that may pose a hazard to workers on a jobsite. In some cases, such field conditions may correspond to processing equipment adjacent a job site, which presents certain hazards, such as gas or fluid release. Additionally or alternatively, the hazards may correspond to atmospheric or other sensors that are configured to relay real-time information regarding field conditions to a central platform. As described in greater detail herein, the systems and methods of the present disclosure may be configured to aggregate and analyze such diverse field conditions in order to generate alerts where such conditions give rise to hazards to nearby crews.

As further shown in FIG. 1, the job field 100 may, more generally, also be associated with a management site 150. The management site 150 be may a centralized control facility that is operable to monitor and manage multiple control sites, such as control site 154, in additions to the control site 104. The systems and methods described herein may allow a user to track ESG compliance across multiple facilities, each with multiple crews and unique field conditions. For example, the control site 104, with continued reference to the oil field, may be a produced water treatment facility with multiple jobsites at different locations within the facility. The control site 154 may be a steam generation facility for enhanced oil recovery with multiple jobsites at different locations within the facility. The systems and methods herein allow for users to identify and mitigate hazards targeted to specific facilities, and specific locations with the facilities in real-time. For example, workers at a first location within the produced water treatment facility can be alerted, during completion of the work, to field conditions that impact the completion of work such that the workers can take different safety measures, including stopping work, if warranted. The systems and methods herein further allow for users to identify and mitigate greenhouse gas and other pollutant-heavy activities. For example, the various integrated sensors of the platform can be used to identify which facilities, which jobsite, and which tasks on the jobsite, produce the highest level of gasses or other pollutants. This information can, in turn, be used to take mitigating action against the most heavily polluting activities in order to meet ESG criteria.

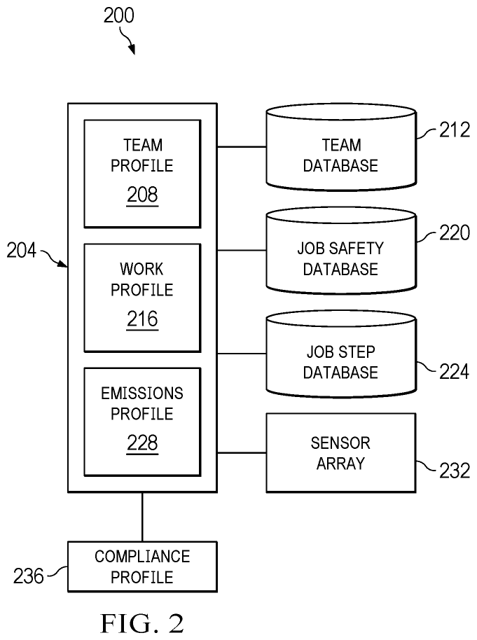

With reference to FIG. 2, a system 200 is disclosed. The system 200 may generally be configured to control a jobsite, according to the operations described herein. To facilitate the foregoing, the system 200 may include a platform 204. The platform 204 may be configured to manage certain environmental, health, and safety risks on a jobsite (such the jobsites 112, 132), and to track various metrics across the jobsite and field for ESG and other compliance related programs. In one example, the platform 204 may include a team profile 208. The team profile 208 may be used in order to associate certain team members with a particular jobsite. For example, the system 200 may include a team database 212 including data attributes that identify a plurality of team members, and associated characteristics of the team members, such as trade type, billing rate, safety compliance, health information, and other relevant characteristics. To illustrate, and with reference to FIG. 1, the platform 204 may be used to associate the workers 114, 115, 116 with the jobsite 112.

The platform 204 further includes a work profile 216. The work profile 216 may be used in order to associate certain job safety and/or job operational steps with a particular jobsite and team member. For example, the system 200 may include a job safety database 220 including data attributes that identify a plurality of safety protocols, and associated mitigation steps for potential hazards of the jobsite, including information associated with personnel protective equipment, process hazards analysis, and safety work best practices. Further, the system 200 may include a job step database 224 including data attributes that identify a plurality of job steps, such as standard operating procedures, including information associated with jobsite-specific information required to complete a scope of work. To illustrate, and with reference to FIG. 1, the platform 204 may be used to associate the field conditions 106-108 with the jobsite 112, in addition to optionally also associating standing operating procedures with the scope of work being completed at the jobsite 112.

The platform 228 further includes an emissions profile 228. The emissions profile 228 may be used in order to associate certain emissions end points with a particular jobsite. For example, the system 200 may include a sensor array 232 that includes various end point sensors that are configured to detect emissions and other pollutants at the jobsite (e.g., such as sensors 120, 122 of FIG. 1). To illustrate, and with reference to FIG. 1, the platform 204 may be used to associate the sensors 120, 122 with the jobsite 112 such that emission of various end points (e.g., heavy equipment, generators, and the like) may be tracked during completion of work on the jobsite 112.

The system 200 of FIG. 2 is further shown as including a dynamic compliance profile 236 generated as a result of the operations of the platform 200 described herein. Broadly, the dynamic compliance profile may be generated by receiving a plurality of jobsite inputs at the jobsite associated with one or more of the team profile 208, the work profile 216, and/or the emissions profile 228. For example, with reference to the team profile 208, the platform 204 may be configured to generate one or more team members compliance metrics in response to an input associated with a physical presence of a team member on the jobsite. The team member compliance metric may further track, for a given team member, time spent on the jobsite, billing rate, and location on the jobsite (and adjacent jobsites). With reference to the work profile 216, the platform 204 may be configured to generate one or more work profile compliance metrics in response to an input associated with at least one of: (i) an acknowledgment of a hazard on the jobsite, (ii) compliance with a standard operating procedure, (iii) an acknowledgment of a safety protocol of the jobsite, and/or other safety or work-related criteria build out in the work profile 216. With reference to the emissions profile 228, the platform 204 may be configured to generate one or more emissions compliance metrics in using data from the sensor array 232. In some cases, the emission compliance metric may be calculated by comparing the data from the sensor array 232 to a base or target value and determining whether the data meets or exceed certain ESG criteria.

The dynamic compliance profile 236 may be transmitted to a plurality of different users, including users remote to the jobsite, in order to facilitate monitoring and tracking of ESG-related criteria. For example, the dynamic compliance profile 236 with respect to the jobsite 112 may be transmitted to users at the control site 104, the management site 150, the control site 154, and/or to users at other locations. Additionally or alternatively, the dynamic compliance profile 236 may be shared among workers of a jobsite in real-time in order to facilitate real-time corrective actions and hazard mitigations.

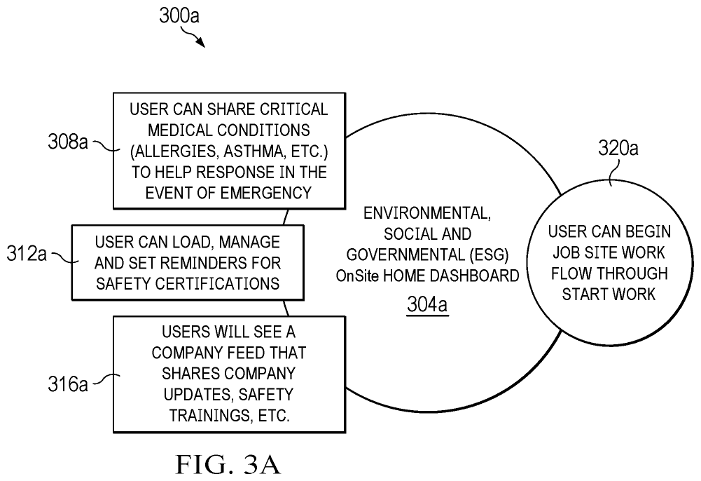

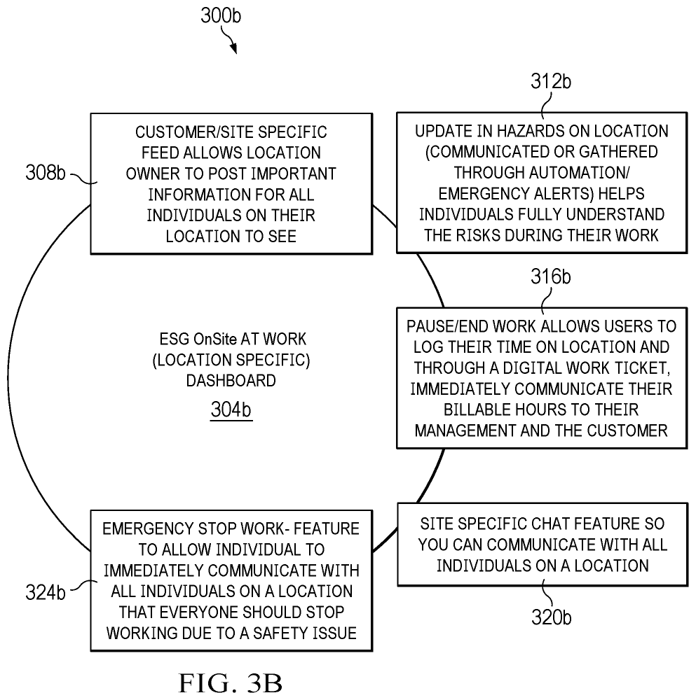

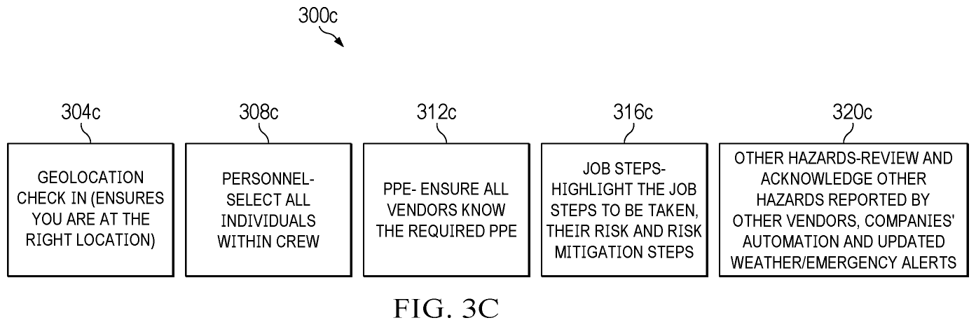

With reference to FIG. 3A, an example functional diagram 300a of a home dashboard 304a is shown. The home dashboard 304a may be executed by the platform 204. The home dashboard 304a may be configured to facilitate building of the team profile 208, the work profile 216, and the emissions profile 228, and/or other relevant profiles for a given jobsite. In the example of FIG. 3A, the home dashboard 304a is shown associated with function 308a, at which a user can share information associated with medical conditions. The home dashboard 304a is further shown associated with function 312a, at which a user can input information associated with safety reminders and certifications. The home dashboard 304a is further shown associated with function 316a, at which users can view a company feed, including information about safety training and protocols. The home dashboard 304a may also be associated with other functions as required for building and viewing the respective profiles. The home dashboard 304a, is further shown associated with function 320a, at which a user can begin a work flow sequence for a given jobsite.

With reference to FIG. 3B, an example functional diagram 300b of an onsite dashboard 304b is shown. The onsite dashboard 304b may be executed by the platform 204. The onsite dashboard 304b may be configured to receive one or more inputs from users on the jobsite (including inputs form sensors) in order to generate the various compliance metrics described herein, including those compliance metrics associated with the team profile, the work profile, and/or the emissions profile. In the example of FIG. 3B, the onsite dashboard 304b is shown associated with function 308b, at which a user can obtain site-specific information, such as from an owner or operator of the jobsite. The onsite dashboard 304b is further shown associated with function 312b, at which a user can obtain information associated with hazards specific to the jobsite, including real-time alerts regarding the risks present on the jobsite. The onsite dashboard 304b is further shown associated with function 316b, at which a user may pause and/or end work in order to track a physical presence on the jobsite, which in turn, may be correlated to a billable rate and/or other metrics associated with the user. The onsite dashboard 304b is further shown associated with function 320b, at which the user can engage with a site specific chart feature to communicate with all individuals on the jobsite. The onsite dashboard 304b is further shown associated with function 324b, at which a user can execute an emergency stop work notification in order to immediately communicate to all workers on the jobsite of a hazard that merits stopping work. The onsite dashboard 304b may also be associated with other functions as required for generating one or more of the compliance metrics described herein.

With reference to FIG. 3C, an example workflow 300c is depicted with reference to controlling a jobsite using the dashboard described herein. Workflow 300c is show as including operation 304c, at which a user verifies a physical presence on the appropriate jobsite using geolocation. Workflow 300c is further shown as including operation 308c, at which personnel select all individuals with a crew. Workflow 300c is further shown as including operation 312c, at which a user may acknowledge personal protective equipment requirements. Workflow 300c is further shown as including operation 316c, at which a user receives and acknowledges job steps, including appropriate mitigation techniques. Workflow 300c is further shown as including operation 320c, at which a user reviews and acknowledges other hazards on the jobsite. It will be appreciate that any of the operations 304c-320c may be used to generate one or more compliance metrics described herein.

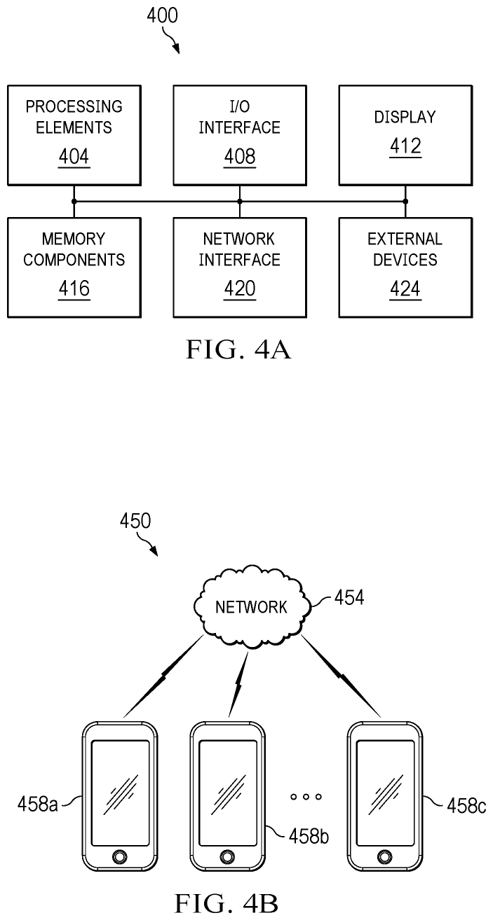

FIG. 4A is a schematic diagram of an example computer system 400 for implementing various embodiments in the examples described herein. A computer system 400 may be used to implement the platform 204 and the system 200 more generally (of FIG. 2). For example, the platform 204 and/or the system 200 may be implemented using one or more of the components of the computer system 400 shown in FIG. 4. The computer system 400 is used to implement or execute one or more of the components or operations disclosed herein, the computer system 400 may include one or more processing elements 402, an input/output interface 404, a display 406, one or more memory components 408, a network interface 410, and one or more external devices 412. Each of the various components may be in communication with one another through one or more buses, communication networks, such as wired or wireless networks.

The processing element 402 may be any type of electronic device capable of processing, receiving, and/or transmitting instructions. For example, the processing element 402 may be a central processing unit, graphics processing unit, microprocessor, processor, or microcontroller. Additionally, it should be noted that some components of the computer 400 may be controlled by a first processor and other components may be controlled by a second processor, where the first and second processors may or may not be in communication with each other.

The memory components 408 are used by the computer 400 to store instructions for the processing element 402, as well as store data, such a data for the team database 212, the job safety database 220, the job step database 224, and/or data associated with the emission monitoring operations described herein. The memory components 408 may be, for example, magneto-optical storage, read-only memory, random access memory, erasable programmable memory, flash memory, or a combination of one or more types of memory components.

The display 406 provides visual feedback to a user. Optionally, the display 406 may act as an input element to enable a user to control, manipulate, and calibrate the home dashboard 304a, the onsite dashboard 304b, and/or other user interface of the platform 204. The display 406 may be a liquid crystal display, plasma display, organic light-emitting diode display, and/or other suitable display. In embodiments where the display 406 is used as an input, the display may include one or more touch or input sensors, such as capacitive touch sensors, a resistive grid, or the like.

The I/O interface 404 allows a user to enter data into the computer 400, as well as provides an input/output for the computer 400 to communicate with other devices or services. The I/O interface 404 can include one or more input buttons, touch pads, and so on.

The network interface 410 provides communication to and from the computer 400 to other devices. The network interface 410 includes one or more communication protocols, such as, but not limited to WiFi, Ethernet, Bluetooth, and so on. The network interface 410 may also include one or more hardwired components, such as a Universal Serial Bus (USB) cable, or the like. The configuration of the network interface 410 depends on the types of communication desired and may be modified to communicate via WiFi, Bluetooth, and so on.

The external devices 412 are one or more devices that can be used to provide various inputs to the computing system 400, e.g., mouse, microphone, keyboard, trackpad, or the like. The external devices 412 may be local or remote and may vary as desired. In some examples, the external devices 412 may also include one or more additional sensors.

In some cases, and with reference to FIG. 4B, the computing system 400 may be server implemented over a distributed network 450. The distributed network may include or otherwise facilitate communication with a plurality of user devices 458a-458c in communication with one another via a network 454. In the implementation of FIG. 4B, the network 454 may include the server of system 400 to facilitate the communication amount the user device 458a-458c and to perform one or more of the operations described herein. The server, or other network enabled device, may include substantially any type of computing device but typically may be one or more computing devices in communication with one another that perform one or more tasks for the user devices 458a-458c. In some embodiments, the server may be a computing device that hosts a web server application or other software application that transmits and receives data to and from the user devices 458a-458c. For example, such server may typically include one or more processing elements, memory components, and networking/communication interfaces, but may generally have a larger processing power and memory storage as compared to the client or user devices 458a-458c.

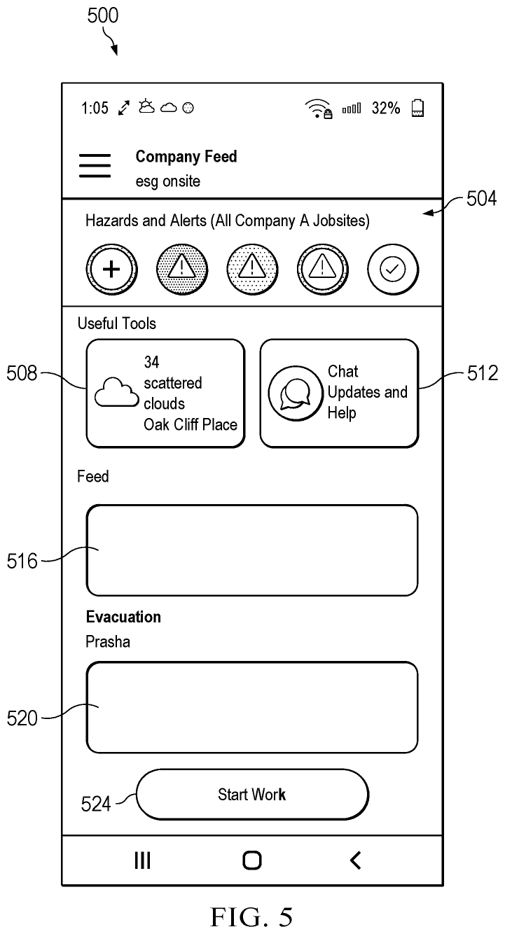

The user devices 458a-458c may also be substantially any type of computing device. Some non-limiting examples include a smartphone, a tablet computer, a digital music player, portable gaming station, laptop computer, set top box, media player (e.g., digital video disc player, digital video recorder), or the like. In many embodiments the user devices 458a-458c are portable computing devices with an integrated display, such as a smart phone. It should be noted that in many embodiments, the distributed network 450 may include a querying user device and responsive or member user devices. The user devices 458a-458b may be configured to display the dashboard 403a, 403b and/or any of the user interfaces described herein in relation to FIGS. 5-13.

With reference to FIG. 5, a user interface 500 is shown. The user interface 500 depicts an example home dashboard interface, such as the home dashboard 304a described herein. The user interface 500 includes a hazards field 504, which may include information associated with hazards of a particular jobsite. The user interface 500 further includes an ambient conditions field 508, which may include information associated with the weather at a particular jobsite, updated in real-time. The user interface 500 further includes a chat field 512, which may be used to access a chat feature for communicating with certain subsets of the workforce, such as those team members on a particular jobsite. The user interface 500 may further include a feed field 516, which may include updates from other members of the jobsite, control site, management site, and/or other users. The user interface 500 may further include an auxiliary field 520, which may include features associated with uploading and receiving information associated with various profiles including functions for loading, managing and setting reminders for safety certifications and/or certain health information. The user interface 524 further includes a start work field 524, which may be selected by a user to start a work process or check in at a given jobsite.

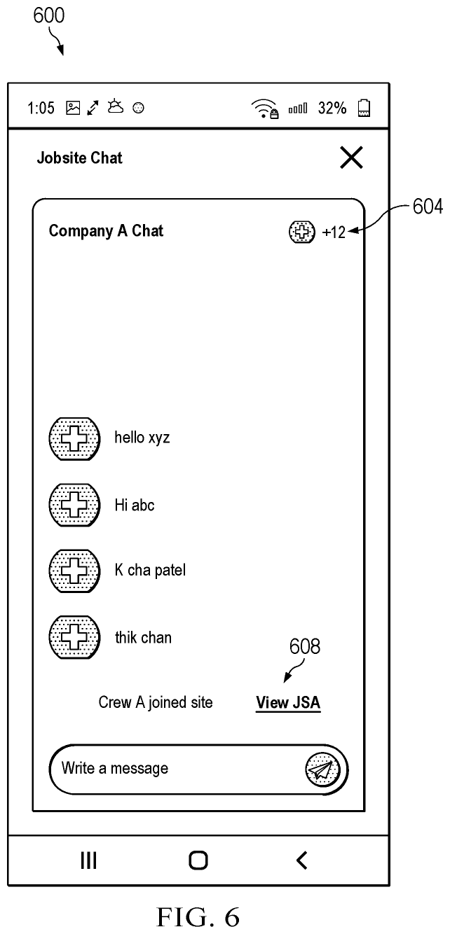

With reference to FIG. 6, a user interface 600 is shown. The user interface 600 depicts an example chat function of the platform 204. From a home dashboard, the user interface 600 can be used to share time-sensitive information with a remote workforce, such as a workforce distributed throughout the job field. From an onsite dashboard, the user interface 600 can be used to chat with all individuals at a certain jobsite. To facilitate the foregoing, the user interface 600 is shown as including a group field 604, which may function to filter the chat to certain workers (e.g., those at a particular jobsite). The user interface is further shown as including a chat field 608, which may be used to send and receive messages with the selected users.

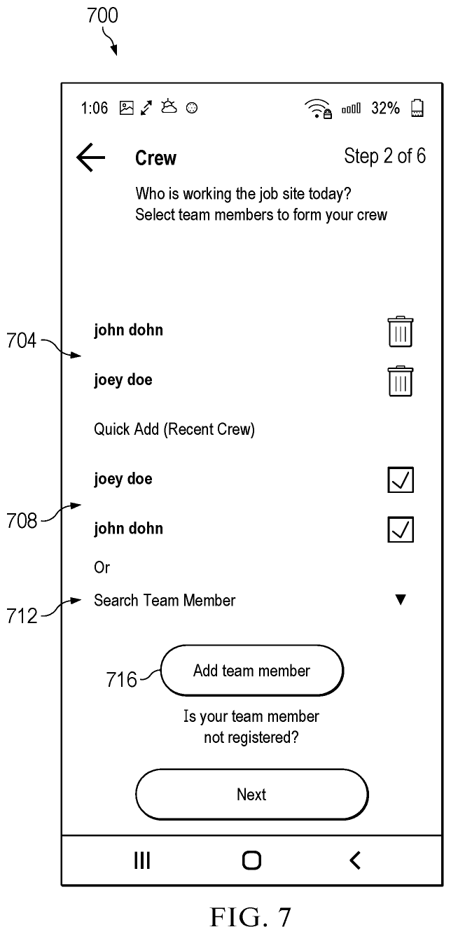

With reference to FIG. 7, a user interface 700 is shown. The user interface 700 depicts an example team profile building function of the platform 204. For example, the user interface 700 can be used to associate attributes of a plurality of team members from a job site database with certain jobsites in order to build a team profile. To facilitate the foregoing, the user interface includes a member field 704, which may be used to show which team members are associated with a jobsite. The user interface 700, further includes a quick add field 708, which may be used to quickly add team members from the team member database to the jobsite. The user interface 700, further includes a search team member field 712, which may be used to query additional team members from the team member database. The user interface 700 further includes an add team member field 716, which may be used to add a team member to the jobsite.

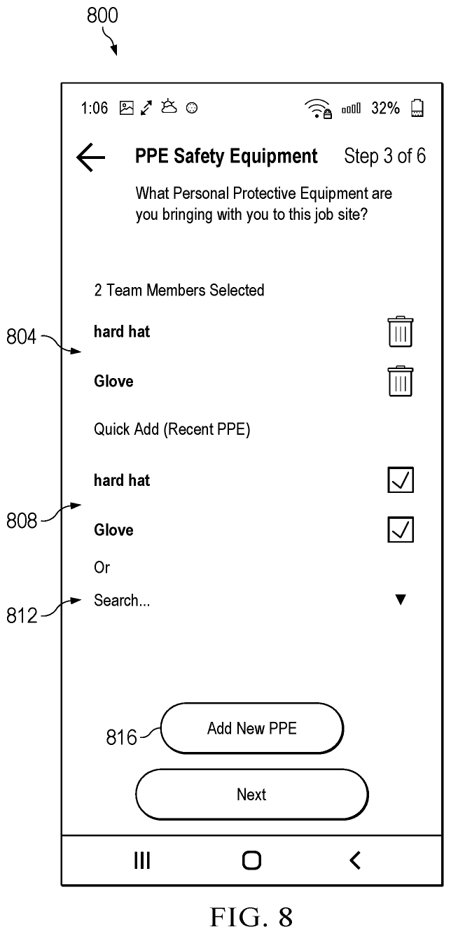

With reference to FIG. 8, a user interface 800 is shown. The user interface 800 depicts an example work profile building function of the platform 204. For example, the user interface 800 can be used to associate job safety attributes from a job safety database with certain jobsite in order to build a work profile. To facilitate the foregoing, the user interface 800 includes a PPE field 804, which may be used to show which items of PPE are currently required in order for the team member to perform work on the jobsite. The user interface 800, further includes a quick add field 808, which may be used to quickly add items of PPE from a job safety database to the jobsite. The user interface 800, further includes a search PPE field 812, which may be used to query additional items of PPEs from the job safety database. The user interface 800 further includes an add PPE field 816, which may be used to add a team member to the jobsite.

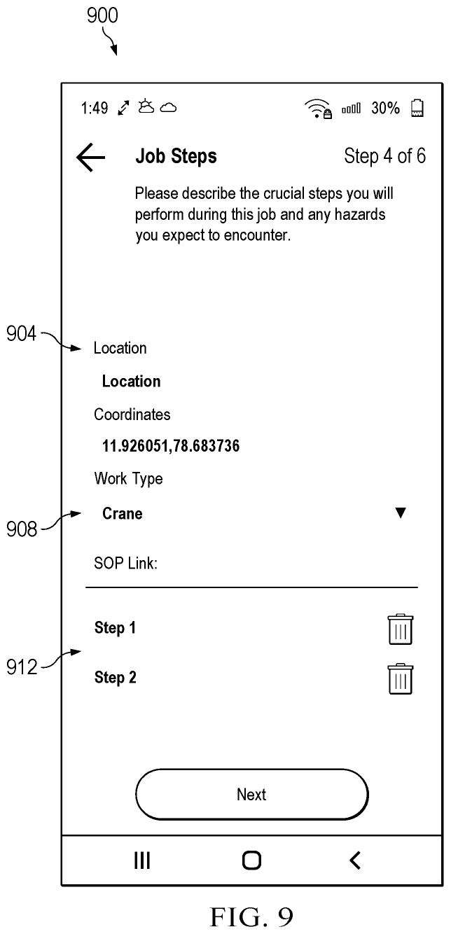

With reference to FIG. 9, a user interface 900 is shown. The user interface 900 depicts another work profile building function of the platform 204. For example, the interface 900 can be used to associate job step attributes from a job step database in order to further build the work profile. To facilitate the foregoing, the user interface 900 includes a location field 904, which may include information associated with a physical location of the jobsite, or location within the jobsite, at which the work is performed. The user interface 900 further includes a work type field 908, which may be used to identify a type of work being performed on the jobsite, such as work involving a crane, as depicted in FIG. 9. The user interface 900 further includes a standard operating procedure (“SOP”) field 912. The SOP field 912 may include a list of various standardized steps, often relating to mitigating safety hazards, that are associate with the type of work shown in the work type field 908.

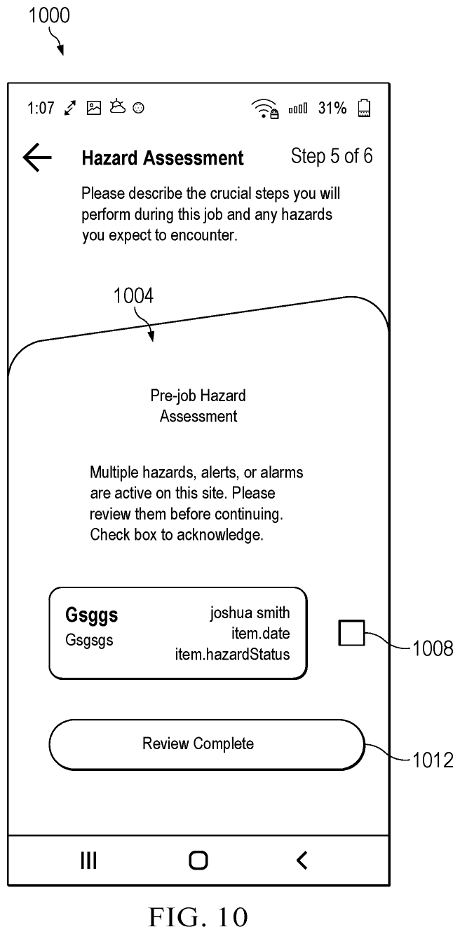

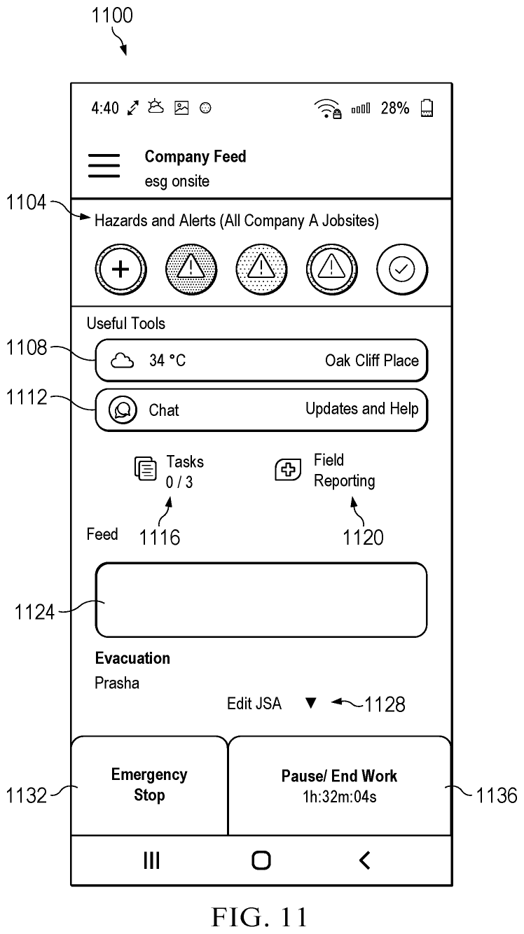

With reference to FIG. 10, a user interface 1000 is shown. The user interface 1000 depicts a compliance metric generating function of the platform 204. For example, the user interface 1000 may be used to confirm team member acknowledgment of hazards at the jobsite. To facilitate the foregoing, the user interface 1000 is shown as including a job hazard field 1004, which may include information associated with hazards on the jobsite. The user interface 1000 further includes an acknowledgment field 1008, which may be configured to receive user input indicative of confirming review of the hazards. The user interface 1000 may further include a review complete field 1012, which may be selected to transmit the acknowledgment of the hazards to other users on the platform 204.

With reference to FIG. 11, a user interface 1100 is shown. The user interface 1100 depicts an onsite dashboard of the platform 204, such as the onsite dashboard 304b of FIG. 3B. The user interface 1100 may include a hazards field 1104, an ambient conditions field 1108, and a chat field 1112, substantially analogous to that described above with reference to the user interface 500. The user interface 1100 further includes a tasks field 1116, which may be used by a worker to review, and acknowledge completion of, tasks on the jobsite. The user interface 1100 further includes a field reporting field 1120, which may allow a worker to report various field conditions to the platform 204, for communication for the plurality of other users, both on the jobsite and remote. The user interface 1100 further includes a feed field 1124, which may allow the onsite work to review relevant updates from users throughout the jobsite, control site, management, and/or other users. The user interface 1100 further includes an edit JSA field, which may allow users on the jobsite to change the work tasks such that a new job safety analysis may be generated associated with the updated scope of work. The user interface 1100 may further include an emergency stop field 1132, which may be used by an on site worker to issues an alert to all others on the jobsite site to cease working due to unsafe field conditions.

The user interface 1100 may further include a timer field 1136, which may be used by an onsite worker in order to track the amount of time spent on a particular jobsite, or a particular task on the jobsite.

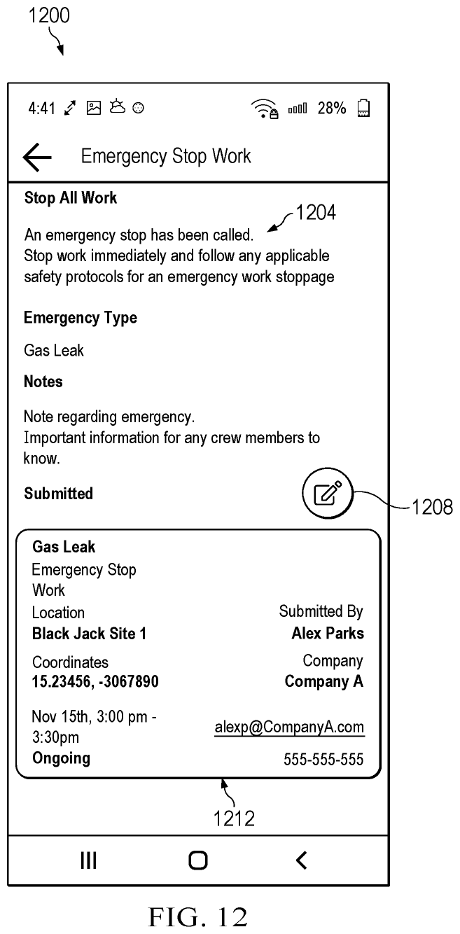

With reference to FIG. 12, a user interface 1200 is shown. The user interface 1200 depicts a stop work function of the platform 204. Broadly, the platform 204 may allow for a single user to issues a notification to all other users on the jobsite, or relevant area, that work should be stopped due to unsafe working conditions. The user interface 1200 may be representative of one such alert. For example, the user interface 1200 includes a notification field 1204, which includes relevant information associated with the stop work event. The user interface 1200 includes a submission field 1208, which includes a function to provide updates and/or initiate a subsequent stop work event. The user interface 1200 further includes a stop work status field 1212, which may include the current status of any stop work event, including details such as the location, submitter, company, and status regarding resolution of any stop work event.

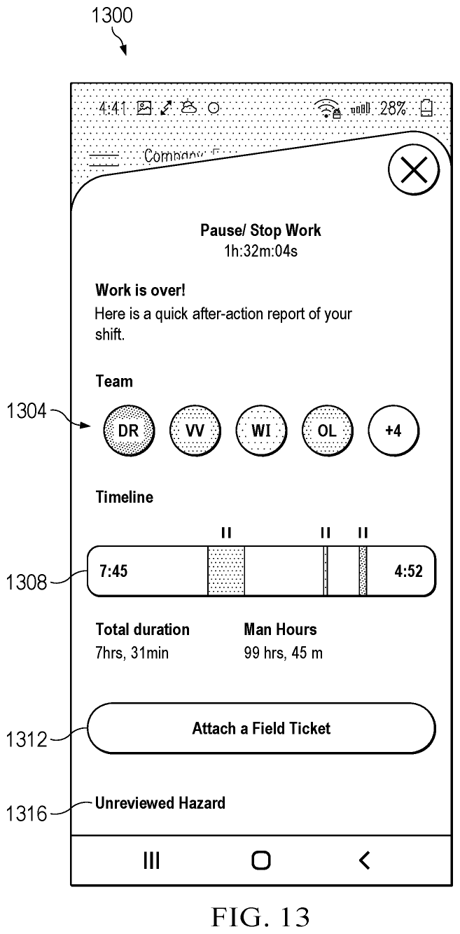

With reference to FIG. 13, a user interface 1300 is shown. The user interface 1300 depicts a work ticket output function of the platform 204. In this regard, the user interface 1300 includes a team member summary field 1304, which may depict the various team members that performed some work, or otherwise checked in to the jobsite, during the work. The user interface 1300 further includes a timeline field 1308, which may depict certain work totals, including total man hours, and the like. The user interface 1300 further includes a field ticket field 1312, which may allow a user to transmit the field ticket to a remote user upon review and confirmation of the information presented at the user interface 1300. The user interface 1300 may further include an unreview hazards field 1316, which may be used by document hazards during the jobsite that were unreviewed or unmitigated in some manner.

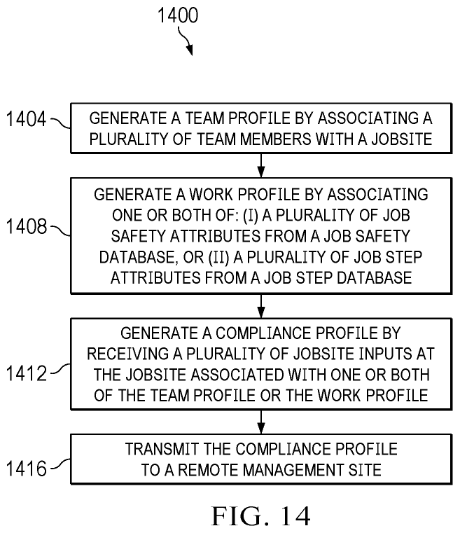

With reference to FIG. 14, a method 1400 is shown for controlling a job site. At operation 1404, a team profile is generated by associating a plurality of team members with a jobsite. For example, and with reference to FIGS. 1 and 2, the platform 204 may associate attributes identifying team members 124, 125, 126 from the team database 212 with the team profile 208 that corresponds to the jobsite 112. At operation 1408, a work profile is generated by associating one or both of: (i) a plurality of job safety attributes from a job safety database, or (ii) a plurality of job step attributes from a job step database. For example, and with reference to FIGS. 1 and 2, the platform 204 may associate a plurality of job safety attributes from the job safety database 220 with the work profile 216 that corresponds to the jobsite 112. Further, the platform 204 may associate a plurality of job step attributes from the job step database 224 with the work profile 216 that corresponds to the jobsite 112. At operation 1412, a dynamic compliance profile is generated by receiving a plurality of jobsite inputs at the jobsite associated with one or both of the team profile or the work profile. For example, and with reference to FIG. 1, a plurality of jobsite inputs may be compared against the respective profiles in order to determine a compliance metric with respect to any given profile of the jobsite 112. At operation 1416, the dynamic compliance profile is transmitted to a remote management site, such as the control site 104, the management site 150, and/or other remote site.

Additionally, the method of FIG. 14 may be used to transmit updates to team members regarding the presence of additional crews and/or any safety conditions that result from or change due the presence of the additional crews. For example, the plurality of team member attributes described above in relation to operation 1404, may be a first plurality of team member attributes that correspond to team members of a first crew. Accordingly, the operation of generating the team profile may further include associating a second plurality of team member attributes with the jobsite that corresponds to team members of a second crew. In turn, the dynamic compliance profile may be updated to include the attributes from the second crew.

Updates associated with the dynamic compliance profile can then be sent to the first crew in response to association of the second plurality of team member attributes with the jobsite, including updates to one or both of the first crew or the second crew in response to receiving a jobsite input that indicates a change in a safety condition of the jobsite.

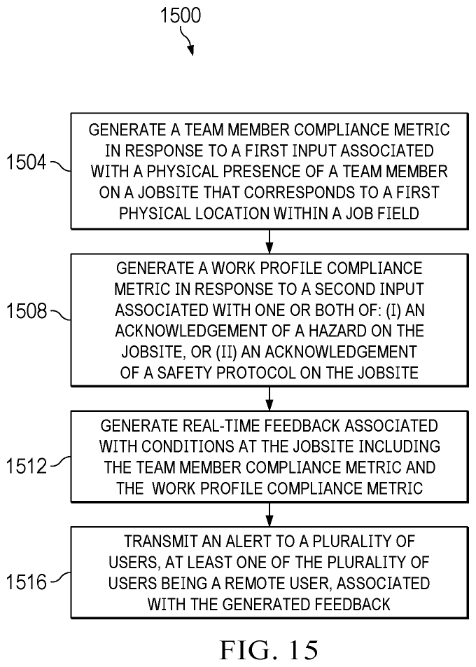

With reference to FIG. 15, a method 1500 is shown for controlling a job site. At operation 1504, a team member compliance metric is generated in response to a first input associated with a physical presence of a team member on a jobsite that corresponds to a first physical location with a job field. For example, and with reference to FIGS. 1 and 2, the platform 204 may receive an input from any of the workers 114, 115, 116 that corresponds to an acknowledgment of the workers physical presence on the jobsite 112. At operation 1508, a work profile compliance metric is generated in response to a second input associated with one or both of: (i) an acknowledgment of a hazard on the jobsite, or (ii) an acknowledgement of a safety protocol on the jobsite. For example, and with reference to FIGS. 1 and 2, the platform 204 may receive an input from any of the workers 114, 115, 116 that corresponds to an acknowledgment of the hazards and/or job steps on the jobsite 112. At operation 1512, real-time feedback is generated associated with conditions at the jobsite including the team member compliance metric and the work profile compliance metric. For example, and with reference to FIGS. 1 and 2, the compliance metrics of the jobsite 112 may be continually updated as field conditions change, including conditions related to new or emerging hazards on the jobsite site. At operation 1516, an alert is transmitted to a plurality of users, at least one of the users being a remove user, associated with the generated feedback, such as a user at the control site 104, the management site 150, and/or other remote site.

The technology described herein may be implemented as logical operations and/or modules in one or more systems. The logical operations may be implemented as a sequence of processor-implemented steps directed by software programs executing in one or more computer systems and as interconnected machine or circuit modules within one or more computer systems, or as a combination of both. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products that cause the instantiation of operations on a computer system to implement the procedural operations. One implementation of a computer program product provides a non-transitory computer program storage medium readable by a computer system and encoding a computer program. It should further be understood that the described technology may be employed in special purpose devices independent of a personal computer.

For example, a computer system includes a processor (which may be referred to as a central processor unit or CPU) that is in communication with memory devices including secondary storage, read only memory (ROM), random access memory (RAM), input/output (I/O) devices 710, and network connectivity devices. The processor may be implemented as one or more CPU chips.

It is understood that by programming and/or loading executable instructions onto the computer system, at least one of the CPU, the RAM, and the ROM are changed, transforming the computer system in part into a particular machine or apparatus having the novel functionality taught by the present disclosure. In the electrical engineering and software engineering arts functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. For example, a design that is still subject to frequent change may be implemented in software, because re-spinning a hardware implementation is more expensive than re-spinning a software design. Meanwhile, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

The secondary storage may be comprised of one or more disk drives or tape drives and is used for non-volatile storage of data and as an over-flow data storage device if RAM is not large enough to hold all working data. Secondary storage may be used to store programs which are loaded into RAM when such programs are selected for execution. The ROM is used to store instructions and perhaps data which are read during program execution. ROM is a non-volatile memory device which typically has a small memory capacity relative to the larger memory capacity of secondary storage. The RAM is used to store volatile data and perhaps to store instructions. Access to both ROM and RAM is typically faster than to secondary storage. The secondary storage, the RAM, and/or the ROM may be referred to in some contexts as computer readable storage media and/or non-transitory computer readable media.

I/O devices may include printers, video monitors, liquid crystal displays (LCDs), touch screen displays, keyboards, keypads, switches, dials, mice, track balls, voice recognizers, card readers, paper tape readers, or other well-known input devices.

The network connectivity devices may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), and/or other air interface protocol radio transceiver cards, and other well-known network devices. These network connectivity devices may enable the processor to communicate with the Internet or one or more intranets. With such a network connection, it is contemplated that the processor might receive information from the network, or might output information to the network in the course of performing the above-described method steps. Such information, which is often represented as a sequence of instructions to be executed using processor, may be received from and outputted to the network, for example, in the form of a computer data signal embodied in a carrier wave.

Such information, which may include data or instructions to be executed using processor for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods known to one skilled in the art.

The processor executes instructions, codes, computer programs, scripts which it accesses from hard disk, floppy disk, optical disk (these various disk based systems may all be considered secondary storage), ROM, RAM, or the network connectivity devices. Multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage, for example, hard drives, floppy disks, optical disks, and/or other device, the ROM, and/or the RAM may be referred to in some contexts as non-transitory instructions and/or non-transitory information.

In an embodiment, the computer system may include two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system to provide the functionality of a number of servers that is not directly bound to the number of computers in the computer system. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an embodiment, some or all of the techniques disclosed herein are related to a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system, at least portions of the contents of the computer program product to the secondary storage, to the ROM, to the RAM, and/or to other non-volatile memory and volatile memory of the computer system. The processor may process the executable instructions and/or data structures in part by directly accessing the computer program product, for example by reading from a CD-ROM disk inserted into a disk drive peripheral of the computer system. Alternatively, the processor may process the executable instructions and/or data structures by remotely accessing the computer program product, for example by downloading the executable instructions and/or data structures from a remote server through the network connectivity devices. The computer program product may comprise instructions that promote the loading and/or copying of data, data structures, files, and/or executable instructions to the secondary storage, to the ROM, to the RAM, and/or to other non-volatile memory and volatile memory of the computer system.

In some contexts, the secondary storage, the ROM, and the RAM may be referred to as a non-transitory computer readable medium or a computer readable storage media. A dynamic RAM embodiment of the RAM, likewise, may be referred to as a non-transitory computer readable medium in that while the dynamic RAM receives electrical power and is operated in accordance with its design, for example during a period of time during which the computer is turned on and operational, the dynamic RAM stores information that is written to it Similarly, the processor may comprise an internal RAM, an internal ROM, a cache memory, and/or other internal non-transitory storage blocks, sections, or components that may be referred to in some contexts as non-transitory computer readable media or computer readable storage media.

In some examples, a non-transitory computer-readable storage medium may store a program or instructions that cause the processor 72 to perform an action described herein. In at least some embodiments, the processor is in communication with a display such that a program or instructions, when executed, cause the processor 70 to provide a user interface on the display that enables a user to interact.

In some aspects, apparatuses, systems, and methods are provided according to one or more of the following examples:

In one example, a method for controlling a jobsite is disclosed. The method includes generating a team profile by associating a plurality of team member attributes with a jobsite that corresponds to a first physical location within a job field. The method further include generating a work profile by associating one or both of: (i) a plurality of job safety attributes from a job safety database, or (ii) a plurality of job step attributes from a job step database. The method further includes generating a dynamic compliance profile by receiving a plurality of jobsite inputs at the jobsite associated with one or both of the team profile or the work profile. The method further includes transmitting the dynamic compliance profile to a remote management site.

In another example, the method includes generating an emissions profile by associating a plurality of emissions end points with the jobsite that corresponds to required equipment for the jobsite. The method further includes generating the dynamic compliance profile by receiving a measured emissions value from the plurality of end points at the jobsite.

In another example, the required equipment includes trucks, power generators, or compressors.

In another example, the method further includes tracking a change in the dynamic compliance profile over time.

In another example, each of the plurality of team members are associated with one or more of a trade, a billing rate, or a safety record.

In another example, the plurality of job safety attributes from the job safety database includes a subset of hazards applicable to, or anticipated on, the jobsite.

In another example, the plurality of job step attributes from the job step database includes a subset of standardized operating procedures applicable to, or anticipated on, the jobsite.

In another example, generating the dynamic compliance profile further includes comparing the plurality of jobsite inputs against both the team profile and the work profile. The plurality of jobsite inputs includes at least one of, for a team member of the plurality of team members: (i) an acknowledgment of a physical presence on the jobsite; (ii) an acknowledgment of a hazard on the jobsite; or (iii) an acknowledgment of a safety protocol on the jobsite.

In another example, the plurality of team member attributes may be a first plurality of team member attributes that correspond to team members of a first crew. In turn, the generating of the team profile may further include associating a second plurality of team member attributes with the jobsite that correspond to team members of a second crew that is different from the first crew.

In another example, the method further includes updating the dynamic compliance profile based on the second plurality of team member attributes.

In another example, the transmitting of the dynamic compliance profile may further include transmitting updates associated with the dynamic compliance profile to the first crew in response to association of the second plurality of team member attributes with the jobsite.

In another example, a system for controlling a jobsite is disclosed. The system includes a first user device including a first location sensor and a first input device. The system further includes a server in communication with the first user device. The server is configured to generate a team profile by associating a plurality of team member attributes with a jobsite that corresponds to a physical location within a job field. The server is further configured to generate a work profile by associating one or both of: (i) a plurality of job safety attributes from a job safety database, or (ii) a plurality of job step attributes from a job step database. The server is further configured to generate a dynamic compliance profile by receiving input from the first input device at the jobsite associated with one or both of the team profile or the work profile. The server is further configured to transmit the dynamic compliance profile to a remote management site.

In another example, a method for controlling a jobsite is disclosed. The method includes generating a team member compliance metric in response to a first input associated with a physical presence of a team member on a jobsite that corresponds to a first physical location with a job field. The method further includes generating a work profile compliance metric in response to a second input associated with one or both of: (i) an acknowledgment of a hazard on the jobsite, or (ii) an acknowledgment of a safety protocol of the jobsite. The method further includes generating real-time feedback associated with conditions at the jobsite including the team member compliance metric and the work profile compliance metric. The method further includes transmitting an alert to a plurality of users, at least one of the plurality of users being a remote user, associated with the generated feedback.

In another example, the real-time feedback may be associated with a jobsite hazard. In turn, the alert may be associated with a stop work notification.

In another example, the jobsite hazard may include a high severity event. In this regard, the method may further include transmitting the alert further includes transmitting the alert to a plurality of users at an adjacent jobsite within the job field.

In another example, the alert may include at least one of: (i) an attribute of the high severity event, or (ii) a mitigation protocol associated with the high severity event.

In another example, the method further includes generating a work summary profile in response to one or more third inputs associated with a completion of a scope of work at the jobsite.

In another example, the team member may be associated with one or more of a trade, a billing rate, or a safety record. In turn, the work summary profile a modified output based on the trade, the billing rate, or the safety record.

In another example, the method further includes generating an emissions profile by associating a plurality of emissions end points with the jobsite that corresponds to required equipment for the jobsite. The method may further include generating an emissions compliance profile by receiving a measured emission value from the plurality of end points at the jobsite.

The method may further include integrating the emissions compliance profile with the work summary profile.

In another example, the jobsite may be a first jobsite. In turn, the method may further include updating the team member compliance metric to reflect a transfer of the team member to a second jobsite that corresponds to a second physical location with a job field. The method may further include a work profile compliance metric in response to a second input associated with one or both of: (i) an acknowledgment of a hazard on the jobsite, or (ii) an acknowledgment of a safety protocol of the jobsite.

In another example, the method further includes receiving real-time feedback from the remote user targeted to the jobsite of a plurality of jobsite of the job field.

In another example, the team member may be first team associated with a first crew. In this regard, the generating of the team member compliance metric may further include generating the team member compliance metric in response to a second input associated with a physical presence of a second team member on the jobsite, the second team member being associated with a second crew that is different from the first crew.

In another example, the generating of the real-time feedback may further include generating real-time feedback in response to the second team member arriving on the jobsite. In this regard, the transmitting of the alert may further include transmitting the alert to the first team member including the real-time feedback generated in response to the second team member arriving on the jobsite.

In another example, a system for controlling a jobsite is disclosed. The system includes a first user device comprising a first location sensor and a first input device. The system further includes a server in communication with the first user device. The server is configured to generate a team member compliance metric in response to a first input received from the first input device associated with a physical presence of a team member on the jobsite. The server is configured to generate a team member compliance metric in response to a second input received from the first input device associated with a physical presence of a team member on the jobsite. The server is further configured to generate real-time feedback associated with conditions at the jobsite including the team member compliance metric and the work profile compliance metric.

The server is further configured to transmit an alert to a plurality of users, at least of the plurality of users being a remote user, associated with the generated feedback.

In addition to the example aspects described above, further aspects and examples will become apparent by reference to the drawings and by study of the following description.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments in this disclosure have been described in terms of preferred embodiments, those skilled in the art will recognize that the embodiments herein can be practiced with modification within the spirit and scope of the embodiments as described herein. Numerous other modifications, equivalents, and alternatives, will become apparent once the above disclosure is fully appreciated. It is intended that the following claims be interpreted to embrace all such modifications, equivalents, and alternatives where applicable.

What is claimed is:

1. A method for controlling a job site, comprising:
generating a team profile by associating a plurality of team member attributes with a job site that corresponds to a first physical location within a job field;
generating a work profile by associating a plurality of job safety attributes from a job safety database with the job site or a plurality of job step attributes from a job step database with the job site;
generating a dynamic compliance profile by receiving a plurality of job site inputs at the job site and comparing the plurality of job site inputs against both the team profile and the work profile; and
alerting a user when a compliance metric of the dynamic compliance profile is out of compliance.

2. The method of claim 1, further comprising:
generating an emissions profile by associating a plurality of emissions end points with the job site that corresponds to required equipment for the job site, and
generating the dynamic compliance profile by receiving a measured emissions value from the plurality of end points at the job site and comparing the measured emissions value against an emissions profile.

3. The method of claim 1, further comprising tracking a change in the dynamic compliance profile over time.

4. The method of claim 1, wherein the plurality of job step attributes from the job step database comprises a subset of standardized operating procedures applicable to, or anticipated on, the job site.

5. The method of claim 1, wherein the plurality of job site inputs comprises, for a team member of the plurality of team members, an acknowledgment of a physical presence on the job site; an acknowledgment of a hazard on the job site; or an acknowledgment of a safety protocol on the job site.

6. The method of claim 1,
wherein the plurality of team member attributes is a first plurality of team member attributes that correspond to team members of a first crew, and
wherein generating the team profile further comprises associating a second plurality of team member attributes with the job site that correspond to team members of a second crew that is different from the first crew.

7. The method of claim 6, further comprising updating the dynamic compliance profile based on the second plurality of team member attributes.

8. The method of claim 6, further comprising transmitting updates associated with the dynamic compliance profile to the first crew in response to association of the second plurality of team member attributes with the job site.

9. The method of claim 6, further comprising transmitting updates to one or both of the first crew or the second crew in response to receiving a job site input that indicates a change in a safety condition of the job site.

10. A method for controlling a job site, comprising:
generating a team member compliance metric in response to a first input associated with a physical presence of a team member on a job site that corresponds to a first physical location within a job field;
generating a work profile compliance metric in response to a second input associated with an acknowledgment of a hazard on the job site or an acknowledgment of a safety protocol of the job site;
generating real-time feedback, based on the compliance metrics, associated with hazardous conditions at the job site; and
alerting a plurality of users, at least one of the plurality of users being a remote user, at least one of the plurality of users being the team member, of the hazardous conditions.

11. The method of claim 10, wherein alerting the plurality of users comprises alerting users at an adjacent job site within the job field of the hazardous conditions.

12. The method of claim 10, wherein the alert comprises an attribute of the hazardous conditions or a mitigation protocol for the hazardous conditions.

13. The method of claim 10, further comprising:
generating an emissions profile by associating a plurality of emissions end points with the job site that corresponds to required equipment for the job site, and
generating an emissions compliance profile by receiving a measured emission value from the plurality of end points at the job site.

14. The method of claim 10, wherein the job site is a first job site, and the method further comprises:
updating the team member compliance metric to reflect a transfer of the team member to a second job site that corresponds to a second physical location with a job field, and
updating the work profile compliance metric in response to a third input associated with an acknowledgment of a hazard on the job site or (an acknowledgment of a safety protocol of the job site.

15. The method of claim 10, wherein the team member is a first team associated with a first crew, and generating the team member compliance metric further comprises generating the team member compliance metric in response to a third input associated with a physical presence of a second team member on the job site, the second team member being associated with a second crew that is different from the first crew.

16. The method of claim 15,
wherein generating the real-time feedback further comprises generating real-time feedback in response to the second team member arriving on the job site, and
wherein alerting the plurality of users further comprises alerting the first team member of the real-time feedback generated in response to the second team member arriving on the job site.

17. A non-transitory computer-readable medium, which when executed by a processor, causes the processor to:
generate a team profile by associating a plurality of team member attributes with a job site that corresponds to a first physical location within a job field;
generate a work profile by associating a plurality of job safety attributes from a job safety database with the job site or plurality of job step attributes from a job step database with the job site;
generate a dynamic compliance profile by receiving a plurality of job site inputs at the job site and comparing the plurality of job site inputs against both the team profile and the work profile; and
alert a user when a compliance metric of the dynamic compliance profile is out of compliance.

18. The computer-readable medium of claim 17, further causing the processor to:
generate an emissions profile by associating a plurality of emissions end points with the job site that corresponds to required equipment for the job site, and
generate the dynamic compliance profile by receiving a measured emissions value from the plurality of end points at the job site and comparing the measured emissions value against an emissions profile.

19. The computer-readable medium of claim 17, wherein the plurality of team member attributes is a first plurality of team member attributes that correspond to team members of a first crew, and generating the team profile further causes the processor to associate a second plurality of team member attributes with the job site that correspond to team members of a second crew that is different from the first crew.

20. The computer-readable medium of claim 19, further causing the processor to update one or both of the first crew or the second crew in response to receiving a job site input that indicates a change in a safety condition of the job site.
